(19) United States
(12) Patent Application Publication
(10) Pub. No.: US 2019/0354352 A1
(43) Pub. Date: Nov. 21, 2019

(54) FACILITATION OF MICROSERVICE USER INTERFACE FRAMEWORK

(71) Applicant: AT&T Intellectual Property I, L.P., Atlanta, GA (US)

(72) Inventors: Vijayarani Natarajan, Norcross, GA (US); William Adams, Hoover, AL (US); Dipak Sahoo, Plano, TX (US)

(21) Appl. No.: 15/983,947

(22) Filed: May 18, 2018

(51) Int. Cl. G06F 8/38; G06F 8/36; G06F 9/451; G06F 9/445

(52) U.S. Cl. CPC G06F 8/38; G06F 9/44526; G06F 9/451; G06F 8/36

(57) ABSTRACT

A microservice plug-in user interface (UI) framework can provide a reusable design pattern for building a generic UI portal implementation for any business domain and sub-domain. This microservice design pattern can define a repeatable UI framework that positively impacts cost, speed, and quality for UI development efforts across the enterprise applications. A method associated with the microservice UI can comprise receiving microservice request data representative of a request for a microservice from a second wireless network device. In response to the receiving the microservice request data, the method can comprise sending the microservice request data to an integration layer, and in response to the sending the microservice request data to the integration layer, the method can comprise receiving the microservice from the integration layer, wherein the microservice modifies a graphical user interface associated with a presentation layer, resulting in a modified graphical user interface.

### TECHNICAL FIELD

This disclosure relates generally to facilitating a microservice user interface framework. More specifically, this disclosure relates to facilitating a microservice user interface for computer-based graphical user interfaces.

### BACKGROUND

Microservices are an example of a software architectural style in which large applications are composed from small loosely coupled services with independent lifecycles. Microservice architecture evolved from the managing of complex monolithic style applications that are built as a single unit. The entire application is packaged into a single web application archive (WAR) or enterprise application archive (EAR). As the application grows and becomes more complex, complications arise. A change to one part of the application may require that the entire application be rebuilt, retested, packaged, and deployed. Another concern is that parts of the application may scale differently than others, thus prompting the entire application to be scaled in effect according to a lowest common denominator.

The above-described background relating to microservice user interface frameworks is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example presentation layer in communication with one or more user devices according to one or more embodiments.

FIG. 2 illustrates an example integration layer comprising one or more databases and microservices according to one or more embodiments.

FIG. 3 illustrates an example microservices system according to one or more embodiments.

FIG. 4 illustrates another microservices system according to one or more embodiments.

FIG. 5 illustrates a microservices system with multiple integration layers according to one or more embodiments.

FIG. 6 illustrates a microservices system with multiple presentation layers according to one or more embodiments.

FIG. 7 illustrates an example schematic system block diagram for layer components according to one or more embodiments.

FIG. 8 illustrates an example flow diagram for a method of facilitating microservices according to one or more embodiments.

FIG. 9 illustrates an example flow diagram for a system for facilitating microservices according to one or more embodiments.

FIG. 10 illustrates a flow diagram for a machine-readable medium for facilitating microservices according to one or more embodiments.

FIG. 11 illustrates an example block diagram of an example mobile handset operable to engage in a system architecture that facilitates secure wireless communication according to one or more embodiments described herein.

FIG. 12 illustrates an example block diagram of an example computer operable to engage in a system architecture that facilitates secure wireless communication according to one or more embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various machine-readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview, various embodiments are described herein to facilitate a microservice user-interface framework for mobile devices and network devices.

For simplicity of explanation, the methods are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a machine-readable storage medium) to facilitate transporting and transferring such methodologies to computers. The term article of manufacture, as used herein, is intended to encompass a computer program accessible from any computer-readable device, carrier, or media, including a non-transitory machine-readable storage medium or a machine-readable storage medium.

Described herein are systems, methods, articles of manufacture, and other embodiments or implementations that can facilitate a microservice user interface framework. Facilitating a microservice user interface framework can be implemented in connection with any type of device with a connection to the communications network such as: a mobile handset, a computer, a handheld device, or the like.

The microservice architectural style composes applications from separate, independent services that provide a single domain capability. This allows parts of the application to be changed and evolve over time without impacting other parts of the application. Microservices are designed to be independently developed, tested, deployed, configured, upgraded, scaled, monitored, and administered. In particular, independent deployment is a fundamental capability. Microservices can be standalone executable processes that cannot be deployed within application servers alongside other services. Microservices can hide implementation details, thus insulating microservice consumers from changes within or downstream from the services they consume.

As part of encapsulation, microservices can keep persistent data private to the service and accessible only via its application program interface (API). Thus, microservices cannot integrate at the data layer nor share the same database or database schema with other services. Additionally, automation of microservices can apply to all aspects of a microservices. Automation embraces development operations, continuous integration, and delivery processes including, but not limited to: automated testing, automated deployment, automated scaling, zero-touch rolling upgrades and/or downgrades, etc. □

Since large applications can comprise many distributed services, it would be desirable to collect, aggregate, and analyze logs and metrics across all services. However, services should be able to detect failures quickly and work around them if possible. Microservices can follow a dumb pipe, smart endpoint approach for communication protocols (e.g., HTTP is a common choice, but lightweight event or message brokers can be acceptable). Since microservices can be auto deployed and infrastructure agnostic, they can be dynamically discoverable. Because consumers can have the ability to query a service registry to look up available instances and then route accordingly, the service can register itself with the service registry when it becomes available.

Users (e.g., product managers/product marketing, strategic pricing, approvers, etc.) of the microservices framework can define and/or update product definitions to build a presentation layer framework. The presentation layer and/or an integration layer can be hosted on a server device accessible by the users. The users can create new products, add new prices, and make changes to define a new product either independently or in collaboration with each other. Thereafter, the graphical user interface (GUI) or user interface (UI) can be reviewed, approved, and/or promoted by one or more users. It should be noted that with regards to this disclosure, GUI and UI can be used interchangeably. Users can also forecast availability for the GUI. In another example, some users may only have access to certain user interfaces. For instance, the product manager can have access to a billing GUI, whereas another user can be precluded from access to the billing GUI. As additional GUI views are developed, they can be plugged into the presentation framework. The GUIs can be tested individually without testing the entire framework. Thus, isolating individual views that plug into the framework can facilitate a more efficient microservices system. The GUIs can also be specific to a business domain (e.g., product, billing, other business capabilities, etc.). The microservice, which supports a view, can be plugged into the presentation layer framework. A domain can also interact with the presentation layer. For example, GUIs and/or data input by the users can be output to the domain (e.g., sales, ordering, billing, etc.) as a function of the GUIs and/or data input by the users.

Microservices utilize a layered architecture to minimize the impact to the system when changes are requested to be made to a GUI. Thus, the presentation layer can send and receive GUIs and other data to and from an integration layer. Microservices can vary at the integration level. For example, some integration microservices services can work with other microservices (e.g., SOR), operate with a cache, and other microservices may not have any data but operate as a processor. Additionally, an integration microservice can also interact with a legacy API. For example, an integration microservice can be a system of record (SOR) microservice to encapsulate data, a microservice that has a local cache, and/or a microservice that calls other microservices or non-microservice application program interfaces (APIs). The principle of data encapsulation states that a microservice can keep persistent data private to the service and accessible via its API. This is regardless of whether the data is system of record data or shared data (cache). The individual microservices within the integration layer can support the views that can be plugged into the framework. For example, if there is a list price UI, there can be a microservice that represents the presentation layer aspect of a list price plug-in widget, for displaying list prices, that would interact with an integration microservice that would then interact with a backend service provider. For example, in order to get the list prices, the system can interact with a system of record microservice, which has a database that contains all of the list prices and has an interface for different users to be able to access that data. Thus, the presentation layer calls the integration layer, and the integration layer calls the backend. There can be one or more calls made in the integration layer. If multiple backend trips are implicated to build a particular response to be displayed in a view, then a workflow can be implemented in the integration microservice.

For example, if a user called (e.g., requested) a list price widget, the presentation layer can call the integration layer, and the integration layer can make a call to the system of record microservice to access the database to retrieve the list price GUI. The system of record microservice can also format the list price GUI according to the user's call, send it to the integration layer, and then the integration layer can send it to the presentation layer. The presentation layer can format the GUI for presentation for that particular widget and then display it to the user. It should be understood that some formatting can also occur at the integration layer (e.g., filters, business rules, joins, transformations, etc.).

The integration layer can also comprise various components (e.g., security, monitoring, load balancing, filtering, etc.). For example, the security component can comprise an authentication and/or an authorization function. The authentication function can identify who the user is at the user interface level. The authorization function can determine which views a user can see. For example, a manager can be able to see views that a general user cannot be authorized to see. Additionally, the authorization can be applied to read and/or write functions of the system based on the user. For example, a manager may be able to edit GUIs and/or microservices, whereas a general user can only view the GUIs. It is also possible that the GUIs in the integration layer comprise security parameters, and the integration microservices can be for/from any domain. For example, the list microservice can directly call a billing integration microservice associated with a billing system and send it to the billing domain. In order to do that, the UI microservice can know that it has access and/or permission to call the integration microservice to send it to the billing domain. Consequently, another security measure involves the UI calling the integration microservice.

The billing domain can also provide data to the integration layer. For example, if a product manager made a price change to one of the products, the presentation layer can send the pricing updates to the integration layer, where the integration layer can capture the pricing and proceed through an approval process. Once the approval process is complete, the integration microservices can call another integration microservice from the billing domain. The pricing can then be sent to the billing domain. Once the billing domain has received the prices, it can acknowledge that it has received, updated, and/or failed to update the prices by sending acknowledgment data to the integration layer. It should be noted that the integration layer can bi-directionally communicate with the billing domain, the presentation layer can bi-directionally communicate with the billing domain, the presentation layer can bi-directionally communicate with the integration layer, and the integration layer can bi-directionally communicate with databases.

It should also be noted that an artificial intelligence (AI) component can facilitate automating one or more features in accordance with the disclosed aspects. A memory and a processor as well as other components can include functionality with regard to the figures. The disclosed aspects in connection with a microservice user-interface framework can employ various AI-based schemes for carrying out various aspects thereof. For example, a process for detecting one or more trigger events, reducing an load balance as a result of the one or more trigger events, and modifying one or more microservices, and so forth, can be facilitated with an example automatic classifier system and process. In another example, a process for penalizing one microservice while preferring another microservice can be facilitated with the example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing mobile device usage as it relates to triggering events, observing network frequency/technology, receiving extrinsic information, and so on). For example, SVMs can be configured via a learning or training phase within a classifier constructor and feature selection module. Thus, the classifier(s) can be used to automatically learn and perform a number of functions, including but not limited to modifying a microservice, modifying one or more rules for microservices, and so forth. The criteria can include, but is not limited to, predefined values, frequency attenuation tables or other parameters, service provider preferences and/or policies, and so on.

In one embodiment, described herein is a method comprising receiving, by a first wireless network device comprising a processor, microservice request data representative of a request for a microservice from a second wireless network device. In response to the receiving the microservice request data, the method can further comprise sending, by the first wireless network device, the microservice request data to an integration layer. Additionally, in response to the sending the microservice request data to the integration layer, the method can comprise receiving, by the first wireless network device, the microservice from the integration layer, wherein the microservice modifies a graphical user interface associated with a presentation layer, resulting in a modified graphical user interface.

According to another embodiment, a system can facilitate, receiving microservice request data associated with a request for a microservice from a wireless network device, and in response to the receiving the microservice request data, sending the microservice request data to an integration layer to facilitate the request for the microservice. In response to the sending the microservice request data to the integration layer, the system can facilitate receiving the microservice from the integration layer. Additionally, in response to the receiving the microservice from the integration layer, the system can facilitate modifying a user interface associated with a presentation layer, resulting in a modified user interface.

According to yet another embodiment, described herein is a machine-readable storage medium that can perform the operations comprising receiving microservice request data representative of a request for a microservice from a wireless network device. Based on the receiving the microservice request data, the operations can comprise sending the microservice request data to an integration layer. Furthermore, in response to the sending the microservice request data to the integration layer, the operations can comprise receiving the microservice from the integration layer, wherein the microservice adjusts a graphical user interface associated with a presentation layer, resulting in a modified graphical interface.

These and other embodiments or implementations are described in more detail below with reference to the drawings.

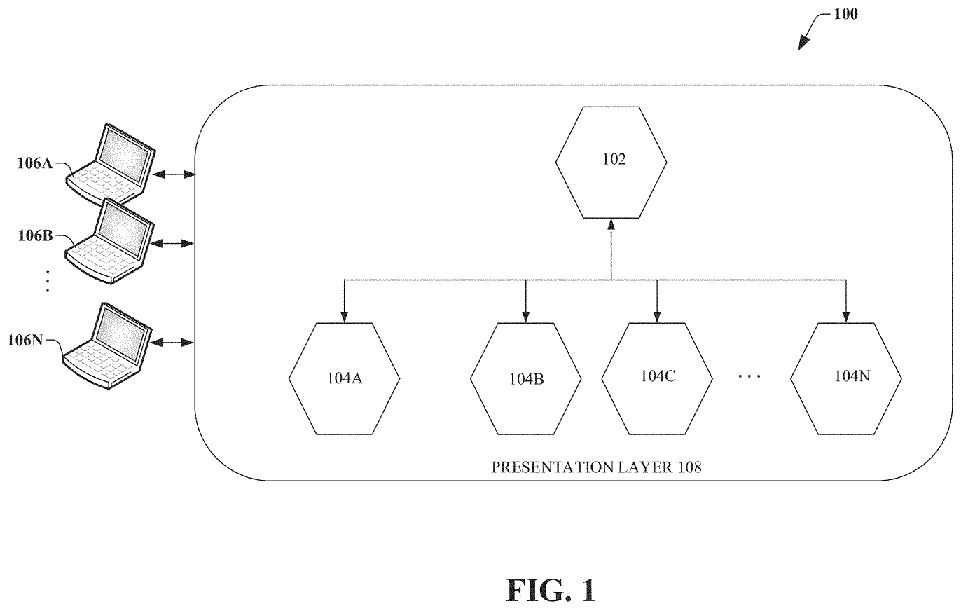

Referring now to FIG. 1, illustrated is an example presentation layer in communication with one or more user devices according to one or more embodiments. The presentation layer 108 can comprise a management portal 102 for interaction with user devices 106A, 106B, 106N that can communicate with the management portal 102 within the microservices architecture 100. It should be noted that any number of user devices can be used by users (e.g., product managers, approvers, etc.) for communication with the presentation layer 108. For example, users can request specific microservice user interfaces (UIs) 104A, 104B, 104C, 104N (e.g., workflow, rules, products, list prices, rate plans, discounts, offers, user management, etc.) to communicate with the management portal 102 as depicted in FIG. 1. It should also be noted that any number of microservice UIs 104A, 104B, 104C, 104N can be in communication with the management portal 102.

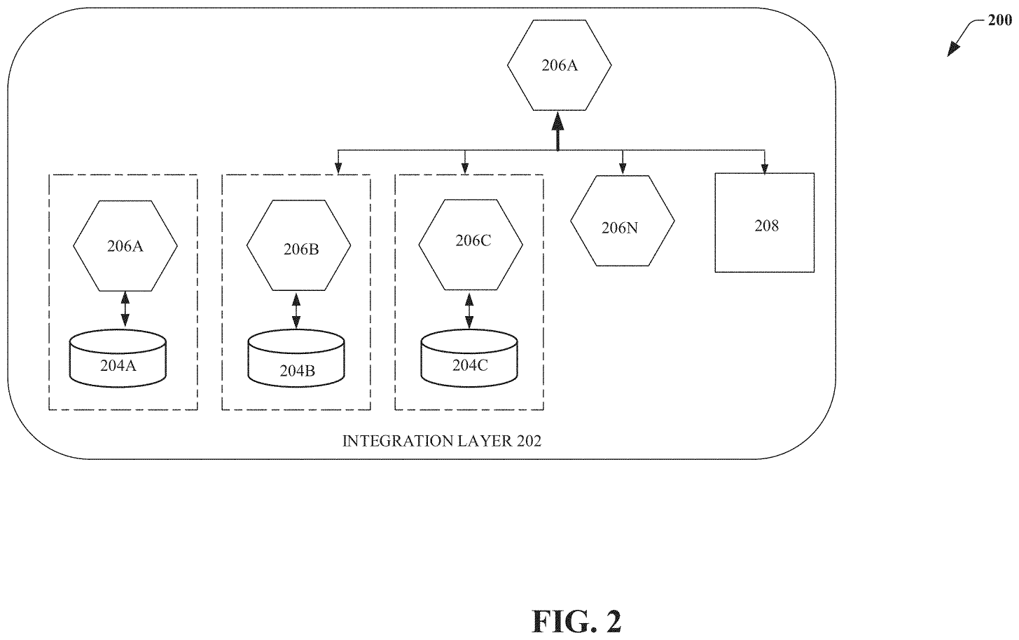

Referring now to FIG. 2, illustrated is an example integration layer comprising one or more databases and microservices according to one or more embodiments. Repetitive description of like elements employed in other embodiments described herein is omitted for sake of brevity.

The presentation layer can talk to the integration layer. The integration layer can have various microservices that integrate with other microservices as a system of record or as a cache. As depicted in FIG. 2, microservices can also interact with another microservice 206N that has no data. Microservices can also interact with a legacy system 208. The integration layer 202 can comprise microservice UIs 206A, 206B, 206C, 206N and a legacy application API 208. The microservice UIs 206A, 206B, 206C, 206N pull from databases 204A, 204B, 204C, 204N in system 200. It should be noted that databases 204A, 204B, 204C can be caches and/or system of record databases and that although only databases 204A, 204B, 204C are depicted, any number of databases can be used. It should also be noted that, although not depicted in the FIGs., every microservice can communicate or have access to its own individual database to prevent microservice integration at the data layer. The presentation layer 108 can send and receive UI data to and from the integration layer 202. The individual microservices within the integration layer 202 that can support the UIs 206A, 206B, 206C, 206N can be sent to the presentation layer 108 to be plugged into the framework. For example, the databases 204A, 204B, 204C that contain the data for the UIs can also comprise an interface for different users to be able to access that data via the user devices 106A, 106B, 106N. Thus, the presentation layer 108 can call upon the integration layer 202, and the integration layer 202 can call upon microservice UIs 206A, 206B, 206C, 206N and their associated databases 204A, 204B, 204C on the backend.

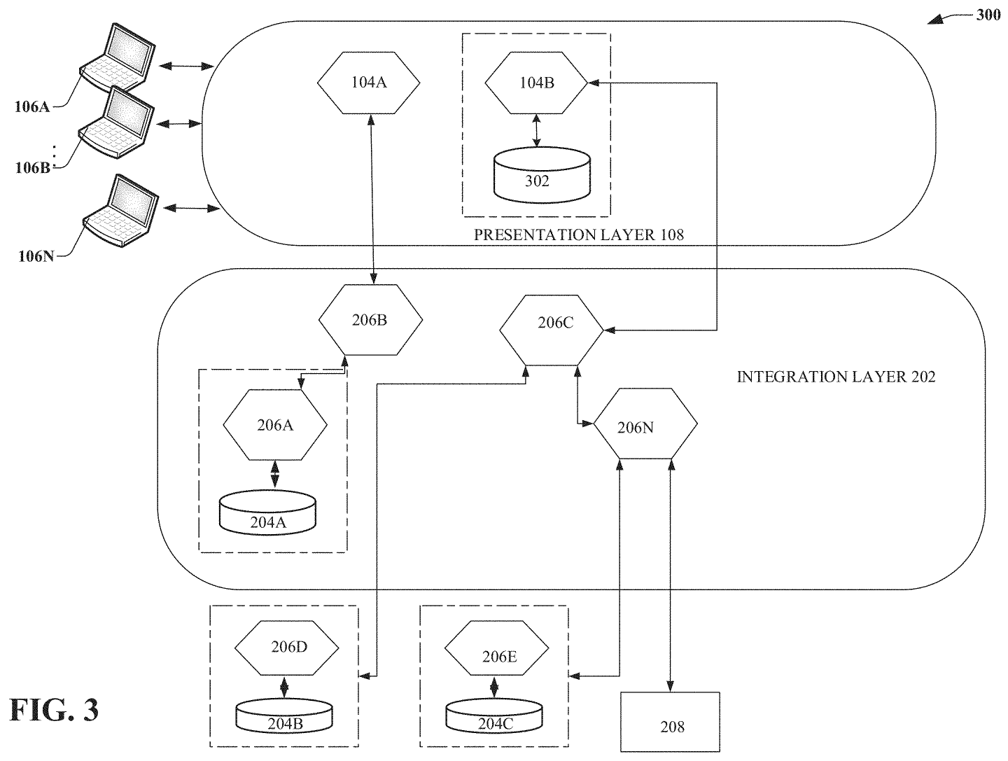

Referring now to FIG. 3, illustrated is an example microservices system 300 according to one or more embodiments. Repetitive description of like elements employed in other embodiments described herein is omitted for sake of brevity. In one or more embodiments, the microservices system 300 can comprise user devices 106A, 106B, 106N, the presentation layer 108, and the integration layer 202, wherein the presentation layer can comprise a microservice 104B and an associated cache database 302. The microservices system 300 can also comprise external microservices 206D, 206E, databases 204B, 204C, and a legacy API 208. For example, if a user called (e.g., requested) a list price widget, the presentation layer 108 can call the integration layer 202, and the integration layer 202 can call a system of record microservice 206D to access one or more of the system of record database 204B to retrieve the list price UI. The system of record microservice 206D can also format the list price UI according to the user's call, send it to the integration layer 202, and then the integration layer 202 can send it to the presentation layer 108. The presentation layer 108 can format the UI for presentation for that particular widget and then it can be displayed to the user via the user devices 106A, 106B, 106N. In some embodiments, the UI can also be formatted at the integration layer 202 via filters, business rules, joining UIs, other transformations, etc. In this and other embodiments, it should be noted that once a microservice is pulled from the integration layer 202 into the presentation layer 108, then the microservice can not be available in the integration layer 202. For example, once the microservice UI 206C is pulled from the integration layer 202 to the presentation layer 108, then the microservice UI 206C can not be available for access in the integration layer 202.

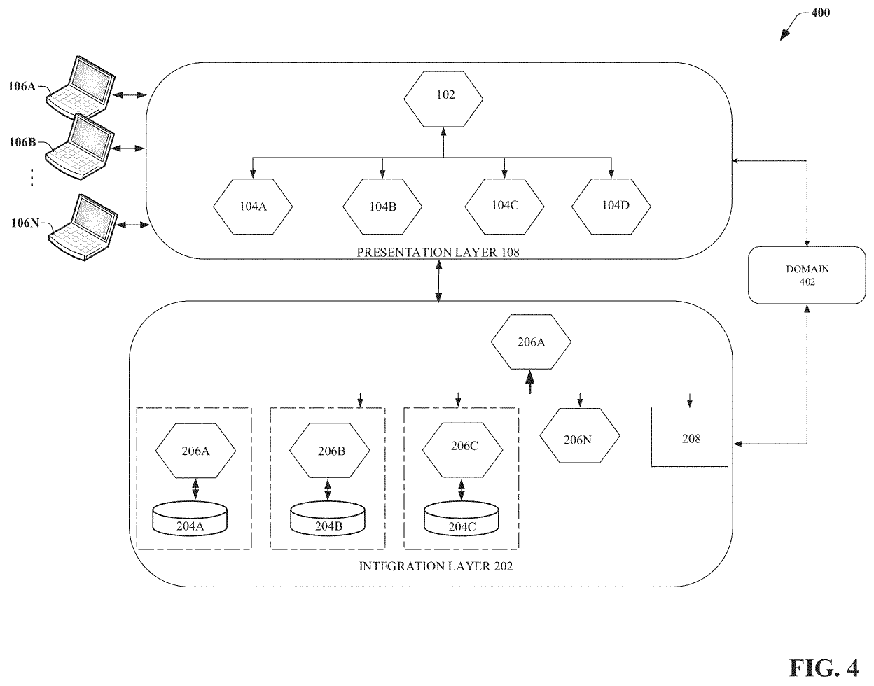

Referring now to FIG. 4, illustrated is another microservices system according to one or more embodiments. Repetitive description of like elements employed in other embodiments described herein is omitted for sake of brevity. In addition to the user devices 106A, 106B, 106N, the presentation layer 108, the integration layer 202, and the databases 204A, 204B, 204C, the system 400 can comprise a domain 402. Although a wide array of possible domains 402 can exist for purposes of microservice architecture, this disclosure primarily discusses an example business domain.

For example, in one or more embodiments, the GUIs can also be specific to a business domain (e.g., product, billing, other business capabilities, etc.). The microservice, which supports a view, can be plugged into the presentation layer 108 framework. The business domain can interact with the presentation layer 108 via bi-directional communication. For example, GUIs and/or data input by the users can be output to the business domain (e.g., sales, ordering, billing) as a function of the GUIs and/or data input by the users.

Additionally, a list microservice can directly call a billing integration microservice associated with a business system and send it to the billing domain. In order to do that, the UI microservice can be granted access and/or permission to call the integration microservice to be sent to the business domain. The domain 402 can also provide data to the integration layer 202. For example, if a product manager made a price change to one of the products via one or more of the user devices 106A, 106B, 106N, the presentation layer 108 can send the pricing updates to the integration layer 202, where the integration layer can capture the pricing and proceed through an approval process. Once the approval process is complete, the integration microservices can call another integration microservice from the domain 402. The pricing can then be sent to the domain 402. Once the domain 402 has received the prices, it can acknowledge that it has received, updated, and/or failed to update the prices by sending acknowledgment data to the integration layer 202. It should be noted that the integration layer 202 can bi-directionally communicate with the domain 402, and the presentation layer 108 can bi-directionally communicate with the integration layer 202.

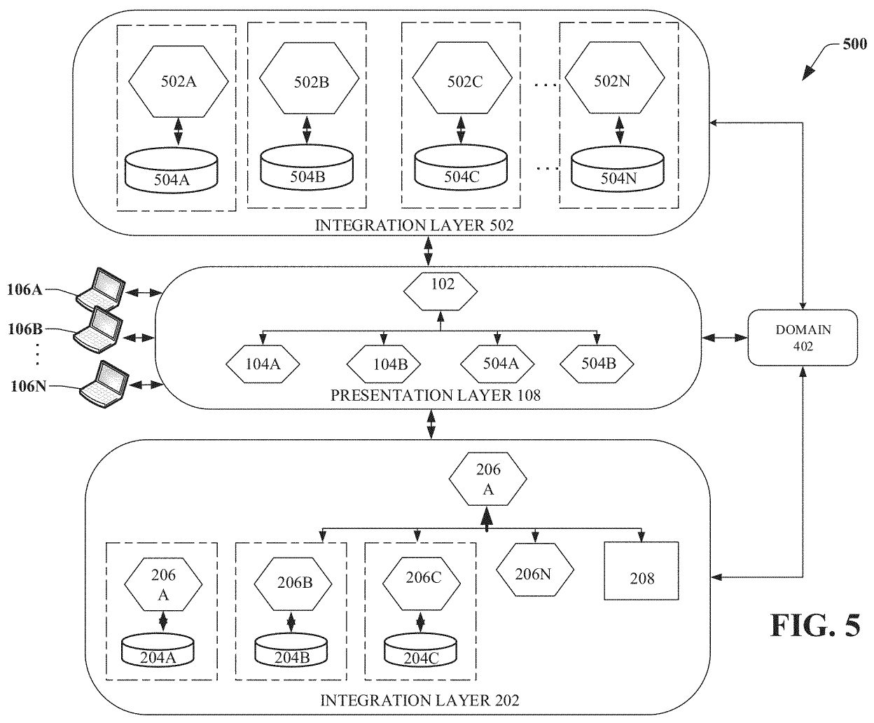

Referring now to FIG. 5, illustrated is a microservices system with multiple integration layers according to one or more embodiments. Repetitive description of like elements employed in other embodiments described herein is omitted for sake of brevity.

In an alternate embodiment, multiple integration layers 202, 502 can be in bi-directional communication with one or more presentation layers 108. It should be noted that although only one presentation layer 108 is depicted in FIG. 5, multiple presentation layers 108 are possible. An additional integration layer 502 can comprise additional microservice UIs 502A, 502B, 502C, 502N, which can be pulled from additional databases 504A, 504B, 504C, 504N, not found within the other integration layer 202. This can allow for a more diverse set of microservice UIs to be called and/or utilized by the users. For example, although a user may request a specific microservice UI 502A, the specific microservice UI 502A may not be available via the integration layer 202. Therefore, the system 500 can request the specific microservice UI 502A from the integration layer 502. This request can be simultaneous with requests to the integration layer 202 or the requests can be chronological order.

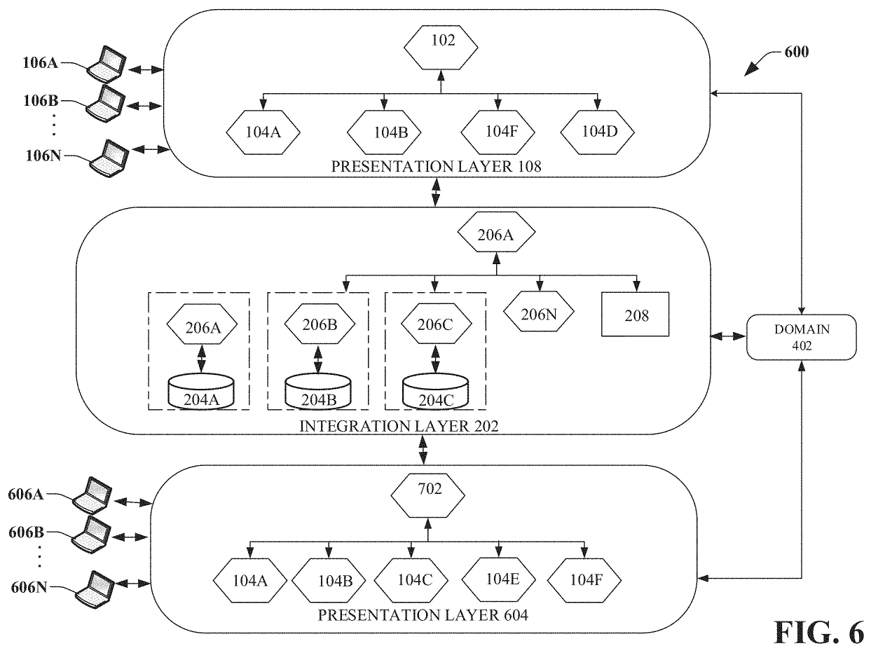

Referring now to FIG. 6, illustrated is a microservices system with multiple presentation layers according to one or more embodiments. Repetitive description of like elements employed in other embodiments described herein is omitted for sake of brevity.

In an additional embodiment, multiple presentation layers 108, 604 can be in bi-directional communication with one or more integration layers 202 in the microservice architecture system 600. It should be noted that although only one integration layer 202 is depicted in FIG. 6, multiple integration layers 202 are possible. An additional presentation layer 604 can comprise additional user devices 606A, 606B, 606N, which can request additional microservice UIs that can be the same or different than the microservice UIs requested by the users of the presentation layer 108. This can allow the integration layer 202 to service one or more presentation layers 108, 604. Thus, the same microservice UIs 104A, 104B, 104C, 104D, 104E, 104F, 104N can be sent from the integration layer 202 to the presentation layers 108, 604.

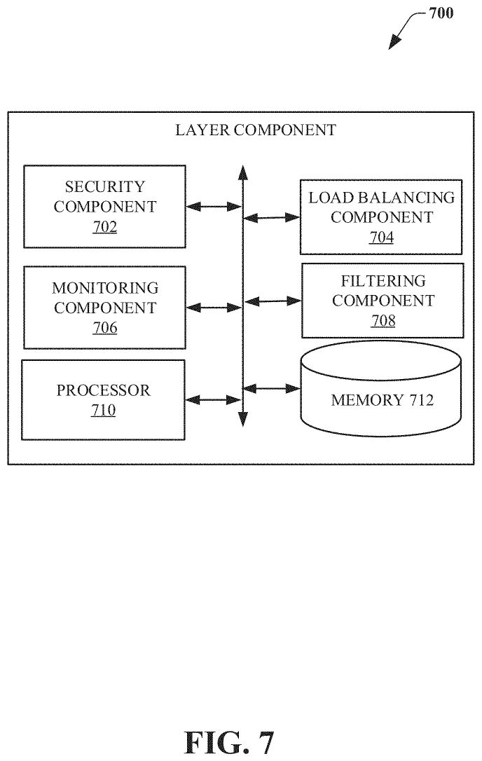

Referring now to FIG. 7, illustrated is an example schematic system block diagram for layer components according to one or more embodiments. Repetitive description of like elements employed in other embodiments described herein is omitted for sake of brevity.

The presentation layer 108 and/or the integration layer 202 can comprise a layer component system 700. The layer component system 700 can comprise several subcomponents (e.g., a security component 702, a load balancing component 704, a monitoring component 706, a filtering component 708, etc.) a processor 710 and a memory 712, which can be electrically and/or communicatively coupled to one another in various embodiments. It should also be noted that, in some embodiments, the subcomponents (e.g., the security component 702, the load balancing component 704, the monitoring component 706, the filtering component 708, etc. and/or other subcomponents not shown) can be external to the layer component system 700.

The security component 702 can comprise an authentication and/or an authorization function. The authentication function can identify who the user is at the user interface level. For example, in response to a request from a user device 106, the authentication functionality of the security component 702 can determine if the user is a manager, a general user, an approver, etc. Various types of authentication can be used including, but not limited to passwords, encryption/decryption methods, biometric, etc. The authorization functionality can determine which UIs a user is privy too, which can also be based on a determination of who the user is via the authentication. Thus, a manager can have additional authorizations (e.g., read, write, modify, edit) that a general user cannot have. Thus, a manager can be able to edit GUIs and/or microservices, whereas a general user can only view the GUIs. The load balancing component 704 can facilitate concurrent running of integration layers 202, 502. Thus, integration can be run concurrently on multiple application servers. The load balancing component 704 can also determine if an application server is down. If the application server is down, the load balancing component 704 can cause the system to automatically register to another microservice running in a different environment.

The monitoring component 706 can monitor the interactions between the user devices 106, the presentation layer 108, and the integration layer 202. The monitoring component 706 can also monitor the feedback loop between the presentation layer 108, the integration layer 202, and the domain 402 to help facilitate microservice efficiencies. The filtering component 708 can filter out certain microservice UIs based on rules that have been applied by the system and/or the user. For example, if the user would like to request billing domain microservice UIs except for rate plans, then the filtering component 708 can filter out any rate plans from the microservice UIs associated with the billing domain. Consequently, no rate plan microservice UIs are returned to the presentation layer 108 because they have been filtered out. It should be noted that capabilities of the aforementioned components can be shared across components. For example, the security component 702 can support user authentication, user authorization, microservice authorization, and/or data store authorization. However, the monitoring component 706 and/or the load balancing component 704 can follow the same pattern of capabilities as the security component 702. Therefore, the functionality of individual components can be applicable for any other component of the layer component system 700.

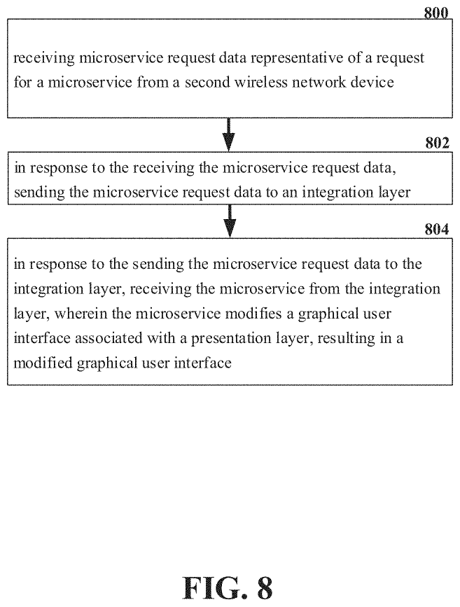

Referring now to FIG. 8, illustrated is an example flow diagram for a method of facilitating microservices according to one or more embodiments. Repetitive description of like elements employed in other embodiments described herein is omitted for sake of brevity.

At element 800, the method can comprise receiving microservice request data representative of a request for a microservice from a second wireless network device (e.g., from a user device 106). The method can also comprise, in response to the receiving the microservice request data, sending (e.g., via a server device), the microservice request data to an integration layer at element 802. Additionally, the method can comprise, in response to the sending the microservice request data to the integration layer, receiving (e.g., via a server device) the microservice from the integration layer at element 804, wherein the microservice modifies a graphical user interface associated with a presentation layer, resulting in a modified graphical user interface.

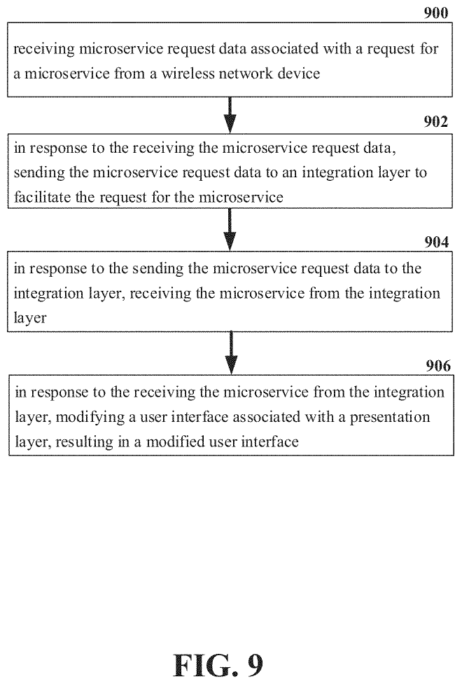

Referring now to FIG. 9, illustrated is an example flow diagram for a system for facilitating microservices according to one or more embodiments. Repetitive description of like elements employed in other embodiments described herein is omitted for sake of brevity.

At element 900, the system operations can comprise, receiving microservice request data associated with a request for a microservice from a wireless network device (e.g. user device 106). The system operations can also comprise sending (e.g., via a server device) the microservice request data to an integration layer 202 to facilitate the request for the microservice in response to the receiving the microservice request data from the user device 106 at element 902. Additionally, in response to the sending (e.g., via the user device 106) the microservice request data to the integration layer, the system operations can comprise receiving (e.g., via the presentation layer 108) the microservice from the integration layer at element 904, and modifying a user interface associated with a presentation layer 108, resulting in a modified user interface in response to the receiving the microservice from the integration layer at element 906.

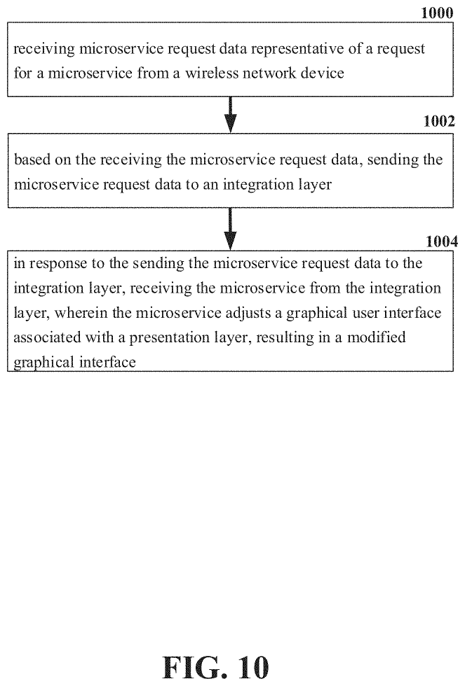

Referring now to FIG. 10, illustrated is an example flow diagram for a machine-readable medium for facilitating microservices according to one or more embodiments. Repetitive description of like elements employed in other embodiments described herein is omitted for sake of brevity.

At element 1000, the machine-readable medium can facilitate receiving (e.g., at the presentation level 108) microservice request data representative of a request for a microservice from a wireless network device (e.g., user device 106). Additionally, the machine-readable medium can facilitate sending (e.g., via the presentation layer 108) the microservice request data to an integration layer 202 based on the receiving the microservice request data at element 1002. Furthermore, at element 1004, the machine-readable medium can facilitate receiving (e.g., via the presentation layer 108) the microservice from the integration layer 202. In response to the sending (e.g., via the presentation layer 108) the microservice request data to the integration layer 202, at element 1004, the machine-readable medium can facilitate receiving the microservice from the integration layer 202, wherein the microservice adjusts a graphical user interface associated with a presentation layer 108, resulting in a modified graphical interface.

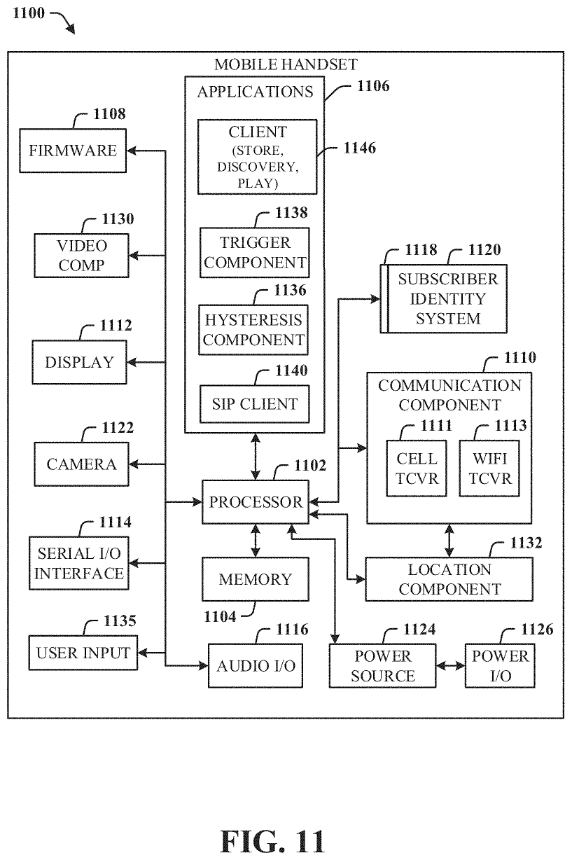

Referring now to FIG. 11, illustrated is a schematic block diagram of an exemplary end-user device such as a mobile device 1100 capable of connecting to a network in accordance with some embodiments described herein. Although a mobile handset 1100 is illustrated herein, it will be understood that other devices can be a mobile device, and that the mobile handset 1100 is merely illustrated to provide context for the embodiments of the various embodiments described herein. The following discussion is intended to provide a brief, general description of an example of a suitable environment 1100 in which the various embodiments can be implemented. While the description includes a general context of computer-executable instructions embodied on a machine-readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1100 includes a processor 1102 for controlling and processing all onboard operations and functions. A memory 1104 interfaces to the processor 1102 for storage of data and one or more applications 1106 (e.g., a video player software, user feedback component software, etc.). Other applications can include voice recognition of predetermined voice commands that facilitate initiation of the user feedback signals. The applications 1106 can be stored in the memory 1104 and/or in a firmware 1108, and executed by the processor 1102 from either or both the memory 1104 or/and the firmware 1108. The firmware 1108 can also store startup code for execution in initializing the handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) and/or an unlicensed transceiver 1113 (e.g., Wi-Fi, WiMax) for corresponding signal communications. The handset 1100 can be a device such as a cellular telephone, a PDA, and/or a tablet device with mobile communications capabilities, and messaging-centric devices. The communications component 1110 also facilitates communications reception from terrestrial radio networks (e.g., broadcast), digital satellite radio networks, and Internet-based radio services networks.

The handset 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor 1102 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software.

The handset 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the handset 1100 and IP-based multimedia content can be received in either an encoded or decoded format.

A video processing component 1122 (e.g., a camera) can be provided for decoding encoded multimedia content. The video processing component 1122 can aid in facilitating the generation, editing and sharing of video quotes. The handset 1100 also includes a power source 1124 in the form of batteries and/or an AC power subsystem, which power source 1124 can interface to an external power system or charging equipment (not shown) by a power I/O component 1126.

The handset 1100 can also include a video component 1130 for processing video content received and, for recording and transmitting video content. For example, the video component 1130 can facilitate the generation, editing and sharing of video quotes. A location tracking component 1132 facilitates geographically locating the handset 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1138 when the Wi-Fi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

The handset 1100, as indicated above related to the communications component 810, includes an indoor network radio transceiver 1113 (e.g., Wi-Fi transceiver). This function supports the indoor radio link, such as IEEE 802.11, for the dual-mode GSM handset 1100. The handset 1100 can accommodate at least satellite radio services through a handset that can combine wireless voice and digital radio chipsets into a single handheld device.

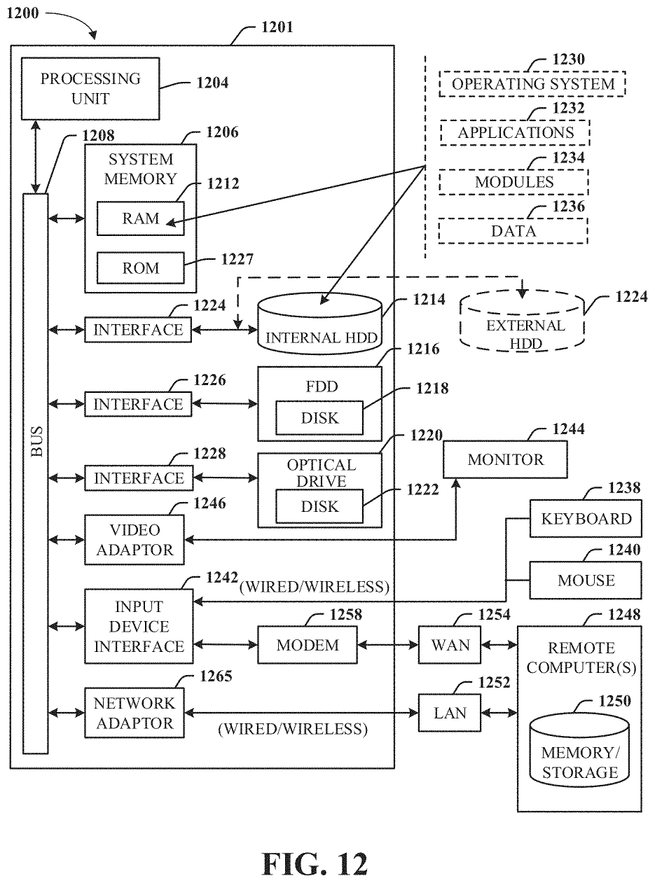

Referring now to FIG. 12, there is illustrated a block diagram of a computer 1200 operable to execute a system architecture that facilitates establishing a transaction between an entity and a third party. The computer 1200 can provide networking and communication capabilities between a wired or wireless communication network and a server and/or communication device. In order to provide additional context for various aspects thereof, FIG. 12 and the following discussion are intended to provide a brief, general description of a suitable computing environment in which the various aspects of the innovation can be implemented to facilitate the establishment of a transaction between an entity and a third party. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 12, implementing various aspects described herein with regards to the end-user device can include a computer 1200, the computer 1200 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1227 and random access memory (RAM) 1212. A basic input/output system (BIOS) is stored in a non-volatile memory 1227 such as ROM, EPROM, EEPROM, which BIOS contains the basic routines that help to transfer information between elements within the computer 1200, such as during start-up. The RAM 1212 can also include a high-speed RAM such as static RAM for caching data.

The computer 1200 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1294 interface technologies. Other external drive connection technologies are within contemplation of the subject innovation.

The drives and their associated computer-readable media provide nonvolatile storage of data, data structures, computer-executable instructions, and so forth. For the computer 1200 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1200, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1200 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 2394 serial port, a game port, a USB port, an IR interface, etc.

A monitor 1244 or other type of display device is also connected to the system bus 1208 through an interface, such as a video adapter 1246. In addition to the monitor 1244, a computer 1200 typically includes other peripheral output devices (not shown), such as speakers, printers, etc.

The computer 1200 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1200 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1200 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the input device interface 1242. In a networked environment, program modules depicted relative to the computer, or portions thereof, can be stored in the remote memory/storage device 1250. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
receiving, by a first wireless network device comprising a processor, microservice request data representative of a request for a microservice from a second wireless network device;
in response to the receiving the microservice request data, sending, by the first wireless network device, the microservice request data to an integration layer;
in response to the sending the microservice request data to the integration layer, receiving, by the first wireless network device, the microservice from the integration layer, wherein the microservice modifies a graphical user interface associated with a presentation layer, resulting in a modified graphical user interface; and
in response to the graphical user interface being modified, isolating, by the first wireless network device, the modified graphical user interface to test the modified graphical user interface.

2. The method of claim 1, further comprising:
sending, by the first wireless network device, the modified graphical user interface to a third wireless network device for display by the third wireless network device.

3. The method of claim 2, further comprising:
in response to the receiving the microservice request data, authenticating, by the first wireless network device, a user identity associated with the second wireless network device.

4. The method of claim 3, wherein the microservice is a first microservice, wherein the request is a first request, and further comprising:
based on a condition associated with the user identity being determined to have been satisfied, restricting, by the first wireless network device, access to a second request for a second microservice.

5. The method of claim 2, further comprising:
in response to the sending the modified graphical user interface to the third wireless network device, receiving, by the first wireless network device, interface data associated with the third network device from the integration layer.

6. The method of claim 1, further comprising:
in response to the receiving the microservice from the integration layer, sending, by the first wireless network device, microservice data associated with the microservice to a user identity, associated with a third wireless network device, to be approved.

7. The method of claim 1, further comprising:
in response to the receiving the microservice request data, sending, by the first wireless network device, the microservice request data to a user identity, associated with a third wireless network device, to be approved.

8. A system, comprising:
a processor; and
a memory that stores executable instructions that, when executed by the processor, facilitate performance of operations, comprising:
receiving microservice request data associated with a request for a microservice from a wireless network device;
in response to the receiving the microservice request data, sending the microservice request data to an integration layer to facilitate the request for the microservice;
in response to the sending the microservice request data to the integration layer, receiving the microservice from the integration layer;
in response to the receiving the microservice from the integration layer, modifying a user interface associated with a presentation layer, resulting in a modified user interface; and
in response to the modifying the user interface, isolating the modified user interface to test the modified user interface.

9. The system of claim 8, wherein the wireless network device is a first wireless network device, and wherein the operations further comprise:
transmitting the modified user interface to a second wireless network device associated with a billing domain.

10. The system of claim 9, wherein the microservice is a discount user interface microservice applicable to the billing domain.

11. The system of claim 10, wherein the discount user interface microservice is a first discount user interface microservice, and wherein the operations further comprise:
in response to the transmitting the modified user interface to the second wireless network device, receiving a second discount user interface microservice to modify the first discount user interface microservice.

12. The system of claim 11, wherein the second discount user interface microservice is received from the integration layer.

13. The system of claim 8, wherein the microservice request data is first microservice request data, wherein the integration layer is a first integration layer, and wherein the operations further comprise:
in response to receiving domain data associated with a billing domain, sending second microservice request data to a second integration layer.

14. The system of claim 13, wherein the second integration layer comprises the microservice in addition to the first integration layer.

15. A machine-readable storage medium, comprising executable instructions that, when executed by a processor, facilitate performance of operations, comprising:
receiving microservice request data representative of a request for a microservice from a wireless network device;
based on the receiving the microservice request data, sending the microservice request data to an integration layer; and
in response to the sending the microservice request data to the integration layer, receiving the microservice from the integration layer, wherein the microservice adjusts a graphical user interface associated with a presentation layer, resulting in a modified graphical interface; and
segregating the modified graphical user interface to test the modified graphical user interface.

16. The machine-readable storage medium of claim 15, wherein the wireless network device is a first wireless network device, and wherein the operations further comprise:
in response to a condition associated with a user identity being determined to have been satisfied, sending the modified graphical interface to a second wireless network device.

17. The machine-readable storage medium of claim 15, wherein the operations further comprise:
facilitating balancing a load associated with microservices of the integration layer.

18. The machine-readable storage medium of claim 17, wherein the integration layer is a first integration layer, and wherein the facilitating the balancing the load comprises offloading the request for the microservice to a second integration layer.

19. The machine-readable storage medium of claim 15, wherein the microservice is stored in a database for access by the integration layer upon the request for the microservice.

20. The machine-readable storage medium of claim 15, wherein the operations further comprise:
monitoring the request for the microservice in accordance with a security condition to determine that an authentication of a user identity has been satisfied; and
based on a determination that the security condition has been satisfied, facilitating access of a user interface to the user identity.
